(19) United States
(12) Patent Application Publication
(10) Pub. No.: US 2016/0296916 A1
(43) Pub. Date: Oct. 13, 2016

(54) HIGHLY ACTIVE SELF-RECOVERABLE COMPOSITE OXIDE CATALYST FOR REVERSE WATER GAS SHIFT REACTION

(71) Applicant: KOREA INSTITUTE OF SCIENCE AND TECHNOLOGY, Seoul (KR)

(72) Inventors: Joosun KIM, Seoul (KR); Donghyun BAE, Seoul (KR); Byungkook KIM, Seoul (KR); Miyoung YOON, Seoul (KR)

(21) Appl. No.: 14/805,077

(22) Filed: Jul. 21, 2015

(30) Foreign Application Priority Data
Apr. 7, 2015 (KR) 10-2015-0049186

(51) Int. Cl. B01J 23/83; B01J 23/00

(52) U.S. Cl. CPC B01J 23/83; B01J 23/002; B01J 2523/00

(57) ABSTRACT

A disclosure is related to a composite oxide catalyst for a reverse water gas shift (RWGS) reaction, which is a reaction for obtaining water and carbon monoxide by reacting hydrogen with carbon dioxide, and particularly, to a self-recoverable composite oxide catalyst for a reverse water gas shift reaction, which is composed of a compound of Ce₁₋ₓMₓO_{2-0.5x} (M is one element selected from the group consisting of Y, La, Nd, Sm, and Gd) and Fe₂O₃ as a composite oxide, thus has an excellent thermal stability at high temperature, and has high carbon dioxide conversion and high carbon monoxide selectivity even under a strong reducing atmosphere, which is a process condition of the reverse water gas shift reaction. Also, the composite oxide exhibits excellent catalytic activity even at the reaction condition of low temperature such as 400° C., and thus enables a large amount of carbon dioxide to be removed at low cost.

### CROSS-REFERENCE TO RELATED APPLICATION

Pursuant to 35 U.S.C. §119(a), this application claims the benefit of earlier filing date and right of priority to Korean Application No. 10-2015-0049186, filed on Apr. 7, 2015, the contents of which is incorporated by reference herein in its entirety.

### BACKGROUND OF THE DISCLOSURE

1. Field of the Disclosure

The present disclosure relates to a composite oxide catalyst for a reverse water gas shift (RWGS) reaction, which is a reaction for obtaining water and carbon monoxide by reacting hydrogen with carbon dioxide, and particularly, to a self-recoverable composite oxide catalyst for a reverse water gas shift reaction, which is composed of a compound of Ce₁₋ₓMₓO_{2-0.5x} (M is one element selected from the group consisting of Y, La, Nd, Sm, and Gd) and Fe₂O₃ as a composite oxide, and thus has an excellent thermal stability at high temperature, and has high carbon dioxide conversion and high carbon monoxide selectivity even under a strong reducing atmosphere, which is a process condition of the reverse water gas shift reaction. Also, the composite oxide exhibits excellent catalytic activity even at the reaction condition of low temperature such as 400° C., and thus enables a large amount of carbon dioxide to be removed at low cost.

2. Background of the Disclosure

Carbon dioxide, which is one of the representative greenhouse gases, serves to be responsible for causing global warming and severe climate change. To overcome these problems, many studies about reduction of emitted carbon dioxide or recycling of emitted carbon dioxide to renewable energy tend to be gradually increased.

One of various methods for reducing carbon dioxide is a reverse water gas shift reaction, which is an inverse reaction of a water gas shift (WGS) reaction to obtain hydrogen and carbon dioxide as products from water and carbon monoxide as reactants.

A large amount of carbon dioxide may be removed through the reverse water gas shift reaction, and various hydrocarbon-based fuels may be obtained by the Fischer-Tropsch process for hydrogenation of carbon monoxide as the product of the reverse water gas shift reaction. Further, it is possible to synthesize methanol using the CAMERE (carbon dioxide hydrogenation to form methanol via a reverse gas shift reaction) process. This process uses the mixture gas of carbon monoxide, hydrogen and carbon dioxide, which is the product or reactant of the reverse water gas shift reaction. That is, the reverse water gas shift reaction may refer to a process which is energetically high in efficiency and eco-friendly.

However, the reverse water gas shift reaction is an endothermic reaction which requires a high temperature above 600° C., and therefore it is essential to use a highly active catalyst material which has an excellent thermal stability and high carbon dioxide conversion even under a strong reducing atmosphere which is a process condition of the reverse water gas shift reaction, in order to reduce carbon dioxide to carbon monoxide.

Generally, noble metals such as Pt, Rh, and Ru show high gas conversion and exhibit high activity in various catalytic reactions including reduction of carbon dioxide. But unfortunately, they are considerably expensive for commercialization. Therefore, Ni metal catalysts which are relatively inexpensive compared to noble metals and have high activity have been widely studied, but they have a problem in that as the number of catalytic reaction cycle is increased, carbon has been deposited on the catalyst surface, thereby accompanying a coking phenomenon that the catalytic activity has been rapidly decreased.

In order to overcome the problem, various researchers have tried to fabricate a highly active composite catalyst for reduction of carbon dioxide, which does not show degradation in performance using a transition metal such as Cu and Zn other than Ni or an oxide including these elements.

For example, Korean Patent Application Laid-Open No. 10-2002-0033333 reported that a catalyst for a reverse water gas shift reaction, which is excellent in thermal stability, was obtained by supporting ZnO onto a certain oxide such as Al₂O₃ or Cr₂O₃, and then a heat treatment at high temperature. In addition, Korean Patent Application Laid-Open No. 10-2005-0028932 fabricated a multicomponent-based catalyst in which Cu was impregnated in a ZnAl₂O₄ oxide in order to synthesize dimethyl ether (DME) by using carbon monoxide obtained from a reverse water gas shift reaction, and Korean Patent Application Laid-Open No. 10-2012-0136077 reported that the carbon dioxide conversion had been improved by fabricating a catalyst in which a Pt precursor was supported onto a TiO₂ support and controlling the size of an active metal.

As described above, the catalyst using a noble metal such as Pt exhibits high activity, but it is so expensive for commercialization that the catalyst is rarely likely as a commercial catalyst material for a reverse water gas shift reaction. Furthermore, when the Pt precursor is fired at a temperature above 600° C., the degree of dispersion of Pt precursor in the TiO₂ support is decreased due to the growth of the particle size, and as a result, the carbon dioxide conversion has been rapidly decreased. Moreover, a Cu-based catalyst has a relatively low melting temperature compared to other metals, and thus, exhibits high activity under a process condition below 300° C., but when the Cu-based catalyst is applied to the reverse water gas shift reaction, its catalytic activity may deteriorate due to low thermal stability. Further, a Zn-based catalyst needs heat treatment at high temperature of 850 to 1,000° C. to have excellent thermal stability, and it brings decrease in specific surface area because the particle size of an active material is getting larger during the heat treatment.

In addition, an Fe-based oxide catalyst was used for a reverse water gas shift reaction (Dae Han Kim et al., Reverse water gas shift reaction catalyzed by Fe nanoparticles with high catalytic activity and stability, Journal of Industrial and Engineering Chemistry, 08/2014), but since the carbon dioxide conversion is up to 35% at a reaction temperature of 600° C., there is room for improvement in catalytic activity.

### SUMMARY OF THE DISCLOSURE

An object of the present disclosure is to provide a catalyst for a reverse water gas shift reaction, which uses an oxide that is capable of repeated redox reaction under the atmosphere of hydrogen and carbon dioxide as reactant gas, that is, self-recoverable, and thus, the oxide catalyst may be re-used, does not include a noble metal, and thus is economical, has an excellent thermal stability at high temperature, has high phase stability even under a strong reducing atmosphere which is a process condition of the reverse water gas shift reaction, has high carbon dioxide conversion and carbon monoxide selectivity. Also, by lowering the activation energy for a gas shift reaction due to high activity, the catalyst has high carbon dioxide conversion and carbon monoxide selectivity even at a low temperature such as 400° C. lower than 600° C., which is a process condition of the reverse water gas shift reaction.

In order to achieve the object, the present disclosure provides a composite oxide catalyst composed of a compound of Ce₁₋ₓMₓO_{2-0.5x} and Fe₂O₃ as a catalyst for a reverse water gas shift reaction, in which M is one element selected from the group consisting of Y, La, Nd, Sm, and Gd, and x is in a range of 0≦x≦0.5.

M in Ce₁₋ₓMₓO_{2-0.5x} may be Gd.

The compound of Ce₁₋ₓMₓO_{2-0.5x} is included in a ratio of 10 to 50 mol % based on the entire composite oxide.

The catalyst is capable of repeated redox reaction.

When the catalyst is used for a reverse water gas shift reaction, the carbon dioxide conversion is 35% or more under the temperature condition of 400° C.

When the catalyst is used for a reverse water gas shift reaction, the carbon monoxide selectivity is 80% or more under the temperature condition of 400° C.

Hereinafter, the present disclosure will be described in more detail with reference to accompanying drawings.

In the present disclosure, carbon dioxide is reduced to carbon monoxide by using an Fe-based material which does not show the degradation in performance by the coking phenomenon and has high thermal stability among multi-valent transition metals. When Fe metal is exposed to the oxidizing atmosphere, it may have various oxidation states, and is easily oxidized to iron oxide such as FeO, Fe₃O₄, and Fe₂O₃. Therefore, when the Fe-based material is exposed to carbon dioxide which is the reactant gas for a reverse water gas shift reaction, the Fe metal or iron oxide such as FeO and Fe₃O₄ serves as a reducing agent to reduce carbon dioxide to carbon monoxide while being oxidized to Fe₂O₃ with a higher oxidation state. When all of the Fe-based materials are oxidized to Fe₂O₃, the conversion of carbon dioxide does not occur any more, and since the catalysts generally serve to accelerate the rate of reaction by lowering the activation energy for the reaction while the state of the catalyst itself is not changed, and so for Fe₂O₃ to function as a catalyst, it has to be recovered to the original state.

As illustrated in FIG. 1, the oxidized Fe₂O₃ is capable of being reduced to the original state such as Fe₃O₄, FeO or Fe metal under the atmosphere of hydrogen, which is another reactant gas for a reverse water gas shift reaction. Moreover, the reduced Fe-based material serves as a reducing agent, which again reduces carbon dioxide to carbon monoxide. In other words, the Fe-based catalyst circulates the redox reaction under the atmosphere of hydrogen and carbon dioxide, which are reactant gases of a reverse water gas shift reaction, and may consume a large amount of carbon dioxide through the repeated self-recovery process.

In addition, the composite oxide catalyst of the present disclosure may facilitate the storage and transport of activated oxide during the redox reaction by using a compound of Ce₁₋ₓMₓO_{2-0.5x}, which is an oxygen storage material including oxygen vacancies in the lattice, and as a result, may improve the catalytic efficiency. In the related art, an oxide such as Al₂O₃, TiO₂, and CeO₂ has been widely used as a support material, and in the present disclosure, Ce₁₋ₓMₓO_{2-0.5x} (M is selected from the group consisting of Y, La, Nd, Sm, and Gd), in which CeO₂ is substituted with the dopant M with a lower atomic valence than Ce in order to further improve storage and transport characteristics for activated oxygen. The oxygen vacancies are formed in the Ce₁₋ₓMₓO_{2-0.5x} oxide lattice in order to maintain the electrical neutrality, and the transport of oxygen is further facilitated through the oxygen vacancies, which may lead to high carbon dioxide conversion. Furthermore, for example, when gadolinium-doped ceria (GDC:M in Ce₁₋ₓMₓO_{2-0.5x} is Gd) is exposed to a strong reducing atmosphere, which is a process condition of a reverse water gas shift reaction, oxygen vacancies are generated since a portion of oxygen escape from the lattice as illustrated in FIG. 1. As described above, while not only oxygen vacancies formed due to substitution of Gd, but also oxygen vacancies additionally formed due to the reducing atmosphere, storage and transport characteristics for activated oxygen may be further improved, thereby enhancing the carbon dioxide conversion and carbon monoxide selectivity.

In general, the difference in size between the solute atoms and the solvent atoms needs to be small in order to form a stable substitution solid solution, and the solvent and solute atoms need to have similar atomic valance and electronegativity each other. The present disclosure intends to improve the catalytic activity by substituting with a solute atom having a lower atomic valence than the solvent atom Ce⁴⁺ to form oxygen vacancies, and examples of the solute atom having a lower atomic valence than Ce⁴⁺ include monovalent alkali metals, divalent alkaline earth metals, and trivalent rare earth metals. However, among them, alkali metals, such as Li⁺ and Na⁺ and alkaline earth metals, such as Ca²⁺ and Sr²⁺ show a substantial difference in ion radius with Ce⁴⁺, and the electronegativity also shows a significant difference by 10% or more, and therefore, it is almost actually impossible for these elements to form a stable solid solution. On the contrary, since trivalent rare earth metals show high solubility in CeO₂ as the difference in ionic radius and electronegativity between Ce⁴⁺ and trivalent rare earth metals is less than 10%, it is possible to produce a large amount of oxygen vacancies. In the present disclosure, it is preferred to use particularly Y, La, Nd, Sm, or Gd among rare earth metals as a solute atom. Since these elements have similar physical and chemical properties, a similar effect may be obtained when Y, La, Nd, or Sm is substituted with instead of Gd exemplified in the following Examples.

As described above, in the present disclosure, a highly active oxide catalyst may be obtained by compositing a self-recoverable Fe-based catalyst with a compound of Ce₁₋ₓMₓO_{2-0.5x}, which is an oxygen storage material.

The self-recoverable composite oxide catalyst for a reverse water gas shift reaction of the present disclosure as described above uses an inexpensive material, has no coking phenomenon, has excellent thermal stability at high temperature, and has high carbon dioxide conversion and carbon monoxide selectivity even under a strong reducing atmosphere, which is a process condition of the reverse water gas shift reaction.

Furthermore, when the composite oxide catalyst according to the present disclosure is used, high carbon dioxide conversion and carbon monoxide selectivity may be obtained even at a low temperature of reaction condition such as 400° C., thereby cost for operating the reverse water gas shift may greatly decrease.

Accordingly, carbon dioxide, which is responsible for causing global warming and severe climate change, may be removed in a large amount at low cost, and carbon monoxide as product may be converted into fuel through the Fischer-Tropsch process, and may be used as an energy source for another device.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 schematically illustrates a reverse water gas shift reaction process using a composite oxide of Fe₂O₃ and Ce₁₋ₓGdₓO_{2-0.5x} according to exemplary embodiments of the present disclosure.

FIG. 2 illustrates a quartz reactor and experimental apparatuses for performing a reverse water gas shift reaction using a composite oxide of Fe₂O₃ and Ce₁₋ₓGdₓO_{2-0.5x} to exemplary embodiments of the present disclosure.

FIG. 3 is a graph illustrating the carbon dioxide conversion according to the reaction temperature in Example 4.

FIG. 4 is a graph illustrating the carbon monoxide selectivity according to the reaction temperature in Example 4.

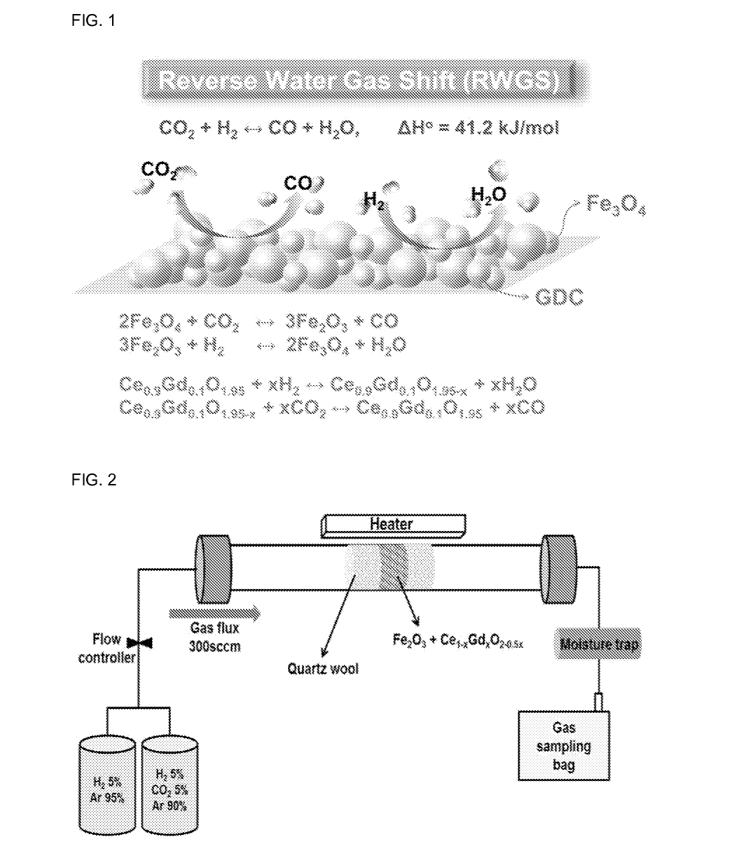

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, exemplary embodiments of the present disclosure will be described in detail with reference to accompanying drawings, such that those skilled in the art to which the present disclosure pertains can easily carry out the present disclosure. However, the present disclosure can be implemented in various different forms, and is not limited to the exemplary embodiments described herein.

Further, the following Examples describe Gd as an example of a doping material, but the doping material with which CeO₂ is substituted is not limited to Gd.

### EXAMPLE 1

### Catalytic Characteristics According to Content of Gd

The Ce_{0.9}Gd_{0.1}O_{1.95} Ce_{0.8}Gd_{0.2}O_{1.9}, Ce_{0.7}Gd_{0.3}O_{1.85}, Ce_{0.6}Gd_{0.4}O_{1.8}, and CeO_{0.5}Gd_{0.5}O_{1.75} powders (products from NEXTECH Co., Ltd., specific surface area: 3.0 m²/g), in which the content ratio x of Gd in Ce₁₋ₓGdₓO_{2-0.5x} was 0.1, 0.2, 0.3, 0.4, and 0.5, respectively, were used.

After 60 mol % of Fe₂O₃ and 40 mol % of the Ce₁₋ₓGdₓO_{2-0.5x} powder were each weighed, a composite powder was prepared by homogeneously mixing and grinding using a ball mill, and drying the product in an oven at 80° C. for 24 hours. 3 g of the composite powder was uniformly dispersed on 0.3 g of quartz wool, and the product was placed in the middle of a quartz reactor as illustrated in FIG. 2. Since a Fe₃O₃-GDC composite powder needs to be pretreated under the reducing atmosphere in order to function as a catalyst for reduction of carbon dioxide through a reverse water gas shift reaction, the temperature was increased at a heating rate of 5° C./min, and a 5% H₂/95% Ar gas was injected at 300 sccm at 400° C. for 1 hour. After the reverse water gas shift reaction, the Fe₂O₃ powder was reduced to Fe₃O₄.

After the reducing heat treatment, the reducing gas remaining in the quartz reactor was completely removed by injecting a reactant gas composed of 5% H₂/5% CO₂/90% Ar, in which the volume ratio of H₂/CO₂ was 1, at 300 sccm for 1 hour, and then a reverse water gas shift reaction was performed. The reaction was carried out at 600° C. for 30 minutes, and then the reacted gas was finally captured in a gas sampling bag with a volume of 10 L, and the gas was analyzed by using gas chromatography. And then, the carbon dioxide (CO₂) conversion and the carbon monoxide (CO) selectivity were calculated by using the following Equations 1 and 2.

CO₂ conversion (%)=(amount of CO₂ inlet×amount of CO₂ outlet)/amount of CO₂ inlet×100 [Equation 1]

CO selectivity (%)=amount of CO outlet/(amount of CO₂ inlet×amount of CO₂ outlet)×100 [Equation2]

The carbon dioxide conversion and the carbon monoxide selectivity at 600° C. according to the content of Gd are shown in the following Table 1.

TABLE 1

x value in Ce₁₋ₓGdₓO_{2-0.5x}

| | 0.1 | 0.2 | 0.3 | 0.4 | 0.5 |
|---|---|---|---|---|---|
| CO₂ conversion (%) | 47.3 | 54.9 | 53.7 | 51.0 | 47.9 |
| CO selectivity (%) | 99.0 | 99.4 | 99.1 | 89.0 | 89.7 |

Referring to Table 1, it can be seen that the catalyst for reverse water gas shift reaction according to the present disclosure exhibits a high carbon dioxide conversion of about 50% and a high carbon monoxide selectivity above 89%, and that when the content x of Gd is 0.2, the catalyst has the highest catalytic activity. This is a much better result than the case where the carbon dioxide conversion in the related art is up to 35%.

### EXAMPLE 2

### Catalytic Characteristics According to Composition Ratio of Fe₂O₃ and GDC

A composite powder was prepared by using the same method as in Example 1, and the composition of Ce₁₋ₓGdₓO_{2-0.5x} was set to Ce_{0.9}Gd_{0.1}O_{1.95}, and the molar ratio of Fe₂O₃:GDC was varied at 9:1, 8:2, 7:3, 6:4, and 5:5, respectively.

The composite powder prepared was pretreated (reducing heat treatment) in the same manner as in Example 1, and then the reverse water gas shift reaction was performed. The reaction temperature for the reverse water gas shift reaction was 600° C., and the gas supplied was 5% H₂/5% CO₂/90% Ar, in which the volume ratio of H₂/CO₂ was 1.

The reacted gas was analyzed by using gas chromatography, and the carbon dioxide conversion and the carbon monoxide selectivity at 600° C. according to the molar ratio of Fe₂O₃ and Ce_{0.9}Gd_{0.1}O_{1.95} are shown in the following Table 2.

TABLE 2

Molar ratio of Fe₂O₃:GDC

| | 9:1 | 8:2 | 7:3 | 6:4 | 5:5 |
|---|---|---|---|---|---|
| CO₂ conversion (%) | 37.6 | 41.2 | 44.8 | 47.3 | 49.1 |
| CO selectivity (%) | 81.5 | 87.3 | 93.4 | 99.0 | 99.2 |

Referring to Table 2, it can be seen that as the molar ratio of GDC was increased, the carbon dioxide conversion and the carbon monoxide selectivity were gradually improved, and this is because the catalytic activity was increased by the addition of GDC which facilitates the storage and transport of activated oxygen through oxygen vacancies during the redox reaction of Fe₂O₃, and the best result was obtained when the molar ratio of Fe₂O₃ and GDC was 1:1.

### EXAMPLE 3

### Catalytic Characteristics According to Composition Ratio of Reactant Gases

A composite powder was prepared by using the same method as in Example 1, and the composition of Ce₁₋ₓGdₓO_{2-0.5x} was Ce_{0.9}Gd_{0.1}O_{1.95}, and the molar ratio of Fe₂O₃:GDC was 6:4.

The composite powder prepared was pretreated (reducing heat treatment) in the same manner as in Example 1, and then the reverse water gas shift reaction was performed. The reaction temperature for the reverse water gas shift reaction was 600° C., and the volume ratio of H₂/CO₂ of the gas supplied was varied at 1, 2, 3, 5, 8, and 10, respectively. The specific composition of gases are the same as shown in the following Table 3.

TABLE 3

| | |
|---|---|
| Gas | Volume ratio of H₂/CO₂ |

| (%) | 1 | 2 | 3 | 5 | 8 | 10 |
|---|---|---|---|---|---|---|
| H₂ | 5 | 10 | 15 | 25 | 40 | 50 |
| CO₂ | 5 | 5 | 5 | 5 | 5 | 5 |
| Ar | 90 | 85 | 80 | 70 | 55 | 45 |

The reacted gas was analyzed by using gas chromatography, and the carbon dioxide conversion and the carbon monoxide selectivity at 600° C. according to the ratio of hydrogen/carbon dioxide supplied are shown in the following Table 4.

TABLE 4

| | Volume ratio of H₂/CO₂ | | | | | |
|---|---|---|---|---|---|---|
| | 1 | 2 | 3 | 5 | 8 | 10 |
| CO₂ conversion | 47.3 | 50.2 | 54.8 | 51.0 | 45.4 | 39.6 |
| (%) | | | | | | |
| CO selectivity (%) | 99.0 | 96.3 | 93.2 | 90.4 | 86.0 | 80.8 |

As can be seen from Table 4, as the volume ratio of the H₂/CO₂ reactant gas was increased, the carbon dioxide conversion was increased, and when the volume ratio was 5 or more, on the contrary, the carbon dioxide conversion and the carbon monoxide selectivity were simultaneously decreased. This is because the forward reaction is predominant due to an excessive amount of hydrogen until a certain ratio, and thus the reduction of carbon dioxide is promoted, but beyond the certain ratio, the efficiency of the reverse water gas shift reaction is rapidly decreased due to a very strong reducing atmosphere.

### EXAMPLE 4

### Catalytic Characteristics According to Various Reaction Temperatures

A composite powder was prepared by using the same method as in Example 1, and the composition of Ce₁₋ₓGdₓO_{2-0.5x} was Ce_{0.9}Gd_{0.1}O_{1.95}, and the molar ratio of Fe₂O₃:GDC was 6:4.

The composite powder prepared was pretreated (reducing heat treatment) in the same manner as in Example 1, and then the reverse water gas shift reaction was performed. The gas supplied for the reverse water gas shift reaction was 5% H₂/5% CO₂/90% Ar, in which the volume ratio of H₂/CO₂ was 1, and the reaction temperature for the reverse water gas shift reaction was varied at 400, 450, 500, 550, 600, 650, and 700° C., respectively.

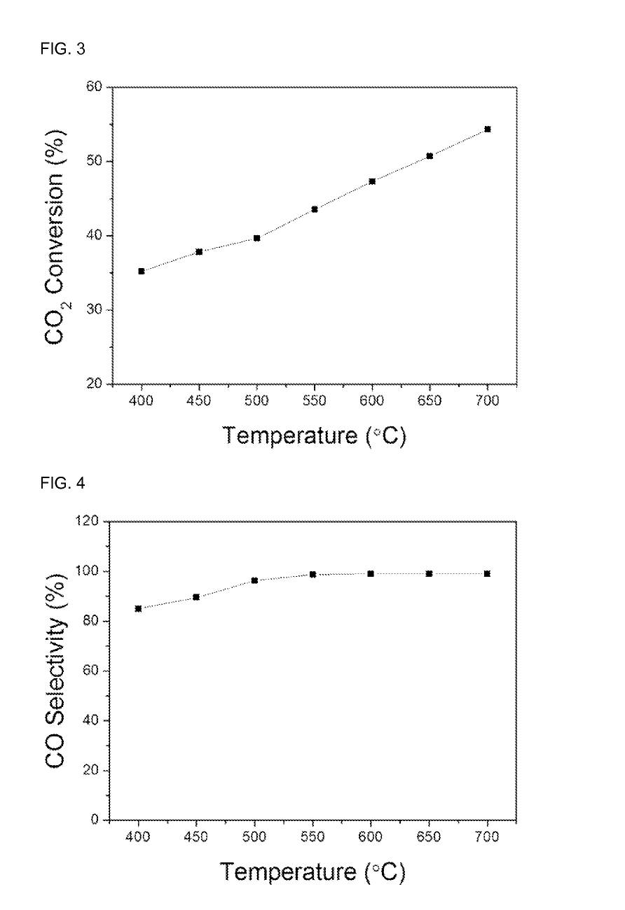

The reacted gas was analyzed by using gas chromatography, and FIGS. 3 and 4 illustrate a change in carbon dioxide conversion and carbon monoxide selectivity according to the reaction temperature.

From FIG. 3, it can be seen that the composite oxide catalyst according to the present disclosure shows a carbon dioxide conversion of approximately 35 to 55% in a range of 400 to 700° C., and as the reaction temperature is increased, the carbon dioxide conversion is increased. Further, as can be seen from FIG. 4, an excellent carbon monoxide selectivity above 80% is exhibited in a range of 400 to 700° C., and as the reaction temperature is increased, the selectivity approaches 100%. The Fe-based catalyst according to the present disclosure is capable of repeated redox reaction under the process condition for the reverse water gas shift reaction, and the storage and transport for activated oxygen are promoted by oxygen vacancies included in Ce₁₋ₓMₓO_{2-0.5x}, thereby lowering the activation energy for the reverse water gas shift reaction. Accordingly, from the composite oxide catalyst according to the present disclosure, it is possible to obtain excellent catalytic characteristics of a carbon dioxide conversion of about 35% and a carbon monoxide selectivity of about 85% even at a low temperature such as 400° C.

### COMPARATIVE EXAMPLE

### Iron Oxide Catalyst

A pre-treatment (reducing heat treatment) was performed in the same manner as in Example 1 by using the Fe₂O₃ powder instead of the Fe₂O₃-GDC composite powder, and then the reverse water gas shift reaction was performed. The reaction temperature for the reverse water gas shift reaction was 600° C., and the gas supplied was 5% H₂/5% CO₂/90% Ar, in which the volume ratio of H₂/CO₂ was 1.

The gas reacted from the reverse water gas shift was analyzed by using gas chromatography, and as a result, the carbon dioxide conversion and the carbon monoxide selectivity were 27.1% and 72.4%, respectively. This exhibits a lower catalytic activity than the result of the reverse water gas shift reaction performed at reaction condition of a low temperature of 400° C. by using the Fe₂O₃-GDC composite powder in Example 4.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A composite oxide catalyst for a reverse water gas shift (RWGS) reaction,
wherein the catalyst is composed of a compound of Ce₁₋ₓMₓO_{2-0.5x} and Fe₂O₃ as a composite oxide, and
M is one element selected from the group consisting of Y, La, Nd, Sm, and Gd, and x is in a range of 0≦x≦0.5.

2. The composite oxide catalyst of claim 1, wherein M in Ce₁₋ₓMₓO_{2-0.5x} is Gd.

3. The composite oxide catalyst of claim 1, wherein the compound of Ce₁₋ₓMₓO_{2-0.5x} is included in a ratio of 10 to 50 mol % based on the entire composite oxide.

4. The composite oxide catalyst of claim 1, wherein the catalyst is capable of repeated redox reaction.

5. The composite oxide catalyst of claim 1, wherein when the catalyst is used for the reverse water gas shift reaction, the carbon dioxide conversion is 35% or more under a temperature condition of 400° C.

6. The composite oxide catalyst of claim 1, wherein when the catalyst is used for the reverse water gas shift reaction, the carbon monoxide selectivity is 80% or more under a temperature condition of 400° C.
